(19) United States
(12) Patent Application Publication
(10) Pub. No.: US 2023/0399505 A1
(43) Pub. Date: Dec. 14, 2023

(54) POLYMERIC COMPOSITE WITH GRAPHENE INCORPORATION

(71) Applicant: PELMEX DA AMAZONIA LTDA, Manaus (BR)

(72) Inventor: LEVON TOPDJIAN FILHO, Manaus (BR)

(73) Assignee: PELMEX DA AMAZONIA LTDA, Manaus (BR)

(21) Appl. No.: 17/835,583

(22) Filed: Jun. 8, 2022

(51) Int. Cl. C08L 67/00; C08L 23/06; C08L 77/02; C08K 3/04

(52) U.S. Cl. CPC C08L 67/00; C08K 3/042; C08L 77/02; C08L 23/06

(57) ABSTRACT

A polymeric composite is described which includes a polymeric matrix made of insulating materials that add properties that allow the industrial processing of graphene without losing its mechanical and conductive properties.

### FIELD OF THE INVENTION

The present invention patent describes a polymeric composite with graphene incorporation, providing a fabric of high tear resistance.

### BACKGROUND OF THE INVENTION

Graphene, one of the crystalline forms of carbon, has the of a flat sheet of densely compacted carbon atoms and just one atom thick, assembled into an hexagonal transparent structure.

This multifunctional material is 200 times stronger than steel, transparent and elastic, and can be immersed in liquid without rust or damage its composition and conducts electricity and heat better than any other component.

For application in the textile industry, graphene proves to be a material with excellent mechanical and conductive properties, providing flexibility and great resistance, allowing to obtain smart fabrics. However, the ideal properties of graphene are available only when it is isolated. When added to another material, these properties decrease.

The incorporation of graphene in polymeric composite is an alternative for various applications in the textile industry. However, the addition of graphene to textile fibers generates rigid fabric pieces, not suitable for use in the textile industry.

Accordingly, the Applicant developed a composite with a polymeric matrix that aggregates properties that allow the industrial processing of graphene without losing its mechanical and conductive properties.

### DETAILED DESCRIPTION OF THE INVENTION

The invention describes, a polymeric composite that includes a polymer matrix consisting of insulating materials associated with graphene, which is a conducting charge.

POLYMERIC COMPOSITE WITH INCORPORATION OF GRAPHENE wherein the composite range: 58.0% to 65.0% of polyester; 16.0% to 25.0% of polyethylene; 12.0% to 20.0% of nylon.

POLYMERIC COMPOSITE range is 1.0% and 5.0% of graphene.

1. POLYMERIC COMPOSITE WITH INCORPORATION OF GRAPHENE wherein the composite range:
58.0% to 65.0% of polyester;
16.0% to 25.0% of polyethylene;
12.0% to 20.0% of nylon and
1.0% and 5.0% of graphene.
